(19) United States
(12) Patent Application Publication
(10) Pub. No.: US 2008/0189098 A1
(43) Pub. Date: Aug. 7, 2008

(54) Language Translator Communicator (LTC)

(76) Inventors: Peter Joseph Mravetz, Centerville, OH (US); Gaylon Wayne Wilkins, Centerville, OH (US)

Correspondence Address: PETER MRAVETZ, 7290 WHITETAIL TRAIL, CENTERVILLE, OH, 45459, US

(21) Appl. No.: 11/670,392

(22) Filed: Feb. 1, 2007

(51) Int. Cl. G06F 17/28

(52) U.S. Cl. 704/3

(57) ABSTRACT

The Language Translator Communicator (LTC) will be incased in a 1.00×2.00×0.50 casing. Input voice will be received through the earpiece to the LTC and translated from input voice to input text mode. After the input text mode has been created the LTC will then translate from input text mode to the output text mode and then translated from output text mode to output voice mode. Example (Spanish Voice to Spanish text translated to English text to English voice.) The benefit of this product will allow easy global communication without the need of a human translator.

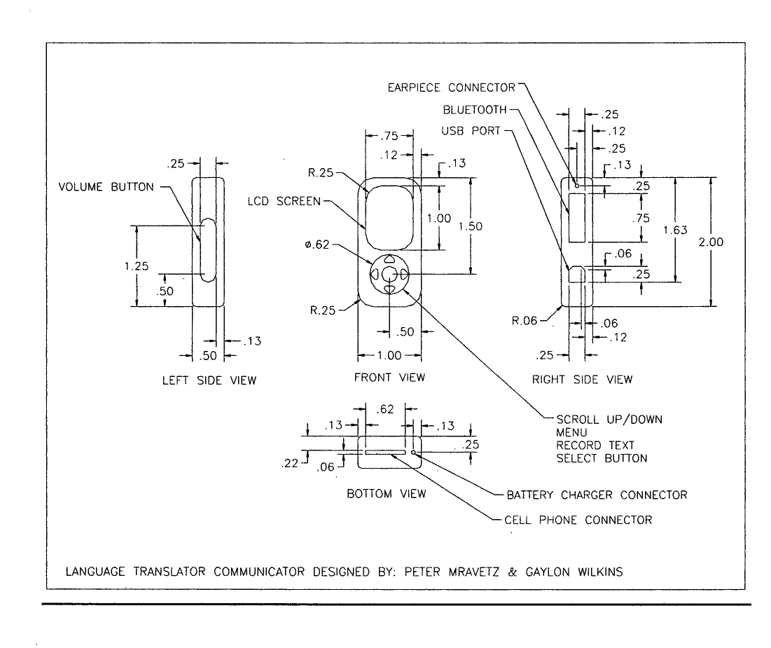

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, OR A COMPUTER PROGRAM LISTING COMPACT DISC APPENDIX

Not Applicable

### BACKGROUND OF THE INVENTION

Not Applicable

### BRIEF SUMMARY OF THE INVENTION

The Language Translator Communicator (LTC) will be incased in a 1.00×2.00×0.50 casing. Input voice will be received through the earpiece to the LTC and translated from input voice to input text mode. After the input text mode has been created the LTC will then translate from input text mode to the output text mode and then translated from output text mode to output voice mode. Example (Spanish Voice to Spanish text translated to English text to English voice.)

### BRIEF DESCRIPTION OF THE SEVERAL VIEWS OF THE DRAWING

Front View of the Language Translator Communicator (LTC) shows a LCD screen to make ease of selecting the proper language to be translated. To select the language on the front of the LTC will also be up/down, menu, enter and record text buttons. Left Side View of the LTC shows a volume select button. Right Side View shows the USB port to link to a computer for upload and down load capability. To receive and send translations the LTC will be Blue tooth capable utilizing an earpiece. The Right Side View also shows a input jack for an earpiece with a wire. Bottom View shows the cellular phone connector and LTC charger connector.

### DETAILED DESCRIPTION OF THE INVENTION

The Language Translator Communicator (LTC) will be incased in a light 1.00×2.00×0.50 casing. On the front side of the LTC will be a LCD screen to make ease of selecting the proper language to be translated. To select the language on the front of the LTC will also be up/down, menu, enter and record text buttons. On the left side of the LTC will have a volume select button. On the right side will include a USB port to link to a computer for upload and down load capability. To receive and send translations the LTC will be Blue tooth capable utilizing an earpiece. The right side will also have an input jack for an earpiece with a wire. The Language Translator Earpiece will be either blue tooth capable or a wire. The earpiece will be the receiver for the voice to be translated into a text mode at the LTC. Input voice will be received through the earpiece to the LTC and translated from input voice to input text mode. After the input text mode has been created the LTC will then translate from input text mode to the output text mode and then translated from output text mode to output voice mode. Example (Spanish Voice to Spanish text translated to English text to English voice.) On the bottom of the LTC will be a cell phone port to utilize with communication over the phone.

1. Under this patent will protect the Language Translator Communicator (LTC) unit, the text and grammar program and how it functions. The text and grammar program will translate the language and will do a grammar check to make a proper translation between languages. The Language Translator Communicator (LTC) will be incased in a light 1.00×2.00×0.50 casing. On the front side of the LTC will be a LCD screen to make case of selecting the proper language to be translated. To select the language on the front of the LTC will also be up/down, menu, enter and record text buttons. On the left side of the LTC will have a volume select button. On the right side will include a USB port to link to a computer for upload and down load capability. To receive and send translations the LTC will be Blue tooth capable utilizing an earpiece. The right side will also have an input jack for an earpiece with a wire. The Language Translator Earpiece will be either blue tooth capable or a wire. The earpiece will be the receiver for the voice to be translated into a text mode at the LTC. Input voice will be received through the earpiece to the LTC and translated from input voice to input text mode. After the input text mode has been created the LTC will then translate from input text mode to the output text mode and then translated from output text mode to output voice mode. Example (Spanish Voice to Spanish text translated to English text to English voice.) On the bottom of the LTC will be a cell phone port to utilize with communication over the phone.
